(19) United States
(12) Patent Application Publication
(10) Pub. No.: US 2015/0166405 A1
(43) Pub. Date: Jun. 18, 2015

(54) MANUFACTURING METHOD FOR TEMPERED GLASS SUBSTRATE, AND TEMPERED GLASS SUBSTRATE

(71) Applicant: Nippon Electric Glass Co., Ltd., Shiga (JP)

(72) Inventors: Takashi MURATA, Shiga (JP); Yoshinari KATO, Shiga (JP)

(21) Appl. No.: 14/611,610

(22) Filed: Feb. 2, 2015

Related U.S. Application Data
(63) Continuation-in-part of application No. PCT/JP2013/071942, filed on Aug. 8, 2013.

(30) Foreign Application Priority Data
Aug. 9, 2012 (JP) 2012-176695

(51) Int. Cl. C03C 21/00; C03C 4/18; C03C 3/093; C03C 3/083; C03C 3/085

(52) U.S. Cl. CPC C03C 21/002; C03C 3/083; C03C 3/085; C03C 3/093; C03C 4/18; C03C 2204/00

(57) ABSTRACT

A manufacturing method for a tempered glass substrate of the present invention includes: melting glass raw materials to obtain molten glass; forming the molten glass into a sheet shape to obtain a glass substrate having a long side dimension of 1,000 mm or more and a short side dimension of 500 mm or more; and performing ion exchange treatment in a state in which the glass substrate is tilted to form a compressive stress layer in a surface of the glass substrate.

### TECHNICAL FIELD

The present invention relates to a manufacturing method for tempered glass and a tempered glass substrate, and more particularly, to a manufacturing method for tempered glass and a tempered glass substrate suitable for a cover glass for a large-screen TV, a digital signage display, a touch panel display, an electronic blackboard, a solar cell, and the like.

### BACKGROUND ART

Devices including a user interface such as an electronic blackboard have been more and more frequently used.

Various operations are performed on a display for those applications, and in this case, the display may break. As one of the methods of solving this problem, there is given a method involving using a glass substrate as a protective member. The glass substrate is required to satisfy the following requirements: (1) high mechanical strength, (2) low density, (3) large size, (4) supply in a large amount at low cost, (5) excellent bubble quality, etc. In particular, in order to satisfy the requirement (1), a glass substrate (so-called tempered glass substrate) subjected to ion exchange treatment has hitherto been used (see Patent Literature 1 and Non Patent Literature 1).

The tempered glass substrate was subjected to ion exchange treatment by immersing a glass substrate to be tempered in a KNO₃ molten salt. Hitherto, the ion exchange treatment has been performed by bringing the KNO₃ molten salt into contact with an entire surface of the glass substrate through use of a tempering jig capable of arranging glass substrates in a vertical direction so as to obtain tempered glass substrates in large amounts at a time. In this case, the glass substrates and the tempering jig are held in contact with each other at a plurality of points.

### CITATION LIST

### Patent Literature

[PTL 1] JP 2006-83045 A

### Non Patent Literature

[NPL 1] Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

In the case of using a small-size tempered glass substrate as in a mobile telephone or the like, the ion exchange treatment can be performed properly by the above-mentioned method. However, when a large-size tempered glass substrate is subjected to ion exchange treatment by the related-art method, the tempered glass substrate is warped significantly. If the warping amount of the tempered glass substrate is large, problems such as entrapment of air, an adhesion defect, and a decrease in device productivity are liable to occur when the tempered glass substrate is bonded onto a display.

The present invention has been made in view of the above-mentioned problems, and it is a technical object of the present invention to provide a method for ion exchange treatment in which even a large-size glass substrate is less liable to be warped.

### Solution to Problem

The inventors of the present invention have made various studies and have consequently found that, although the temperature of an ion exchange solution is sufficiently lower than the strain point of a glass substrate, the glass substrate is thermally deformed during a preheating step and an annealing step included in a series of ion exchange treatment, which causes warping, and this problem is liable to become conspicuous, in particular, as the glass substrate becomes larger (and thinner), and found that the thermal deformation of the glass substrate can be suppressed by a method of supporting a glass substrate during ion exchange treatment. Thus, the findings are proposed as the present invention. Specifically, the manufacturing method for a tempered glass substrate of the present invention comprises: melting glass raw materials to obtain molten glass; forming the molten glass into a sheet shape to obtain a glass substrate having a long side dimension of 1,000 mm or more and a short side dimension of 500 mm or more; and performing ion exchange treatment in a state in which the glass substrate is tilted to form a compressive stress layer in a surface of the glass substrate.

Second, it is preferred that, in the manufacturing method for a tempered glass substrate of the present invention, the ion exchange treatment be performed in a state in which the glass substrate is tilted by from 0.1° to 30° with respect to a vertical direction. Herein, FIG. 1 is a conceptual diagram illustrating a tilt angle of a glass substrate G. As illustrated in FIG. 1, an angle θ at which the glass substrate G is tilted with respect to a vertical direction corresponds to a tilt angle.

Third, it is preferred that, in the manufacturing method for a tempered glass substrate of the present invention, the ion exchange treatment be performed in a state in which the glass substrate is tilted by causing a tilt support portion provided in a support jig to support the glass substrate. Herein, the term “tilt support portion” refers to, for example, a portion that is tilted at an angle corresponding to the tilt angle of the glass substrate and supports the glass substrate. It should be noted that the tilt support portion is preferably formed of a plurality of members from the viewpoint of supporting the glass substrate stably.

A specific example of the support jig according to the present invention is described below.

FIG. 2 illustrates a first example of the support jig 2 according to the present invention. As illustrated in FIG. 2, the support jig 2 includes a frame portion 3 and a plurality of members (a pair of support frame materials) 4, 5 forming the tilt support portion. The frame portion 3 has a rectangular solid shape in which an upper frame 3a and a lower frame 3b each having a substantially rectangular shape are coupled to each other through four columns at four corners. Upper ends of the pair of support frame materials 4, 5 are coupled to a frame material 3aa on one side of the upper frame 3a and lower ends thereof are coupled to a frame material 3bb on the other side of the lower frame 3b, and a support surface formed by the pair of support frame materials 4, 5 has a predetermined tilt angle in the frame portion 3. The glass substrate G is supported in a state in which an end portion on a long side (or an end portion on a short side) extends off from an outer end of the pair of support frame materials 4, 5 outwardly by 1 mm or more and keeps a tilted posture by being partially held in contact with the pair of support frame materials 4, 5. Further, the support jig 2 includes side part reinforcing frame materials 3ca, 3cb that extend from each coupled part between the pair of support frame materials 4, 5 and the frame material 3aa on one side of the upper frame 3a in a vertically downward direction to be coupled to a frame material 3ba on one side of the lower frame 3b and bottom part reinforcing frame materials 3da, 3db that extend from each coupled part between the pair of support frame materials 4, 5 and the frame material 3ba on one side of the lower frame 3b to be coupled to the frame material 3bb on the other side of the lower frame 3b.

FIG. 3 illustrates a second example of the support jig 2 according to the present invention. The support jig 2 illustrated in FIG. 3 further includes a plurality of (two in the illustrated figure) coupling frame materials 3ea, 3eb for coupling the pair of support frame materials 4, 5 arranged substantially in parallel at a distance, compared to the support jig 2 illustrated in FIG. 2. The coupling frame materials 3ea, 3eb are coupled to the pair of support frame materials 4, 5 in a direction substantially perpendicular to the pair of support frame materials 4, 5. The glass substrate G is also supported by the coupling frame materials 3ea, 3eb to be held stably in a tilted posture. Then, the coupling frame materials 3ea, 3eb are present on an upper side and a lower side of the glass substrate G.

FIG. 4 illustrates a third example of the support jig 2 according to the present invention. The support jig 2 illustrated in FIG. 4 further includes a tilt frame material 3fa between the pair of support frame materials 4, 5 arranged substantially in parallel at a distance, compared to the support jig 2 illustrated in FIG. 2. The tilt frame material 3fa is provided so as to couple an upper part of one of the support frame materials 4 to a bottom part of the other support frame material 5. The glass substrate G is also supported by the tilt frame material 3fa to be held stably in a tilted posture.

FIG. 5 illustrates a fourth example of the support jig 2 according to the present invention. The support jig 2 illustrated in FIG. 5 further includes side part reinforcing frame materials 3ga, 3gb that extend from coupled parts between the pair of support frame materials 4, 5 and the frame material 3bb on the other side of the lower frame 3b in a vertically upward direction to be coupled to the frame material 3ab on the other side of the upper frame 3a, compared to the support jig 2 illustrated in FIG. 2. The movement of the glass substrate G in a diagonally downward direction is regulated with the side part reinforcing frame materials 3ga, 3gb.

FIG. 6 illustrates a fifth example of the support jig 2 according to the present invention. The support jig 2 illustrated in FIG. 6 further includes a pair of shift preventing frame materials 3ha, 3hb, compared to the support jig 2 illustrated in FIG. 5. The pair of shift preventing frame materials 3ha, 3hb extends from the bottom part reinforcing frame materials 3da, 3db in a diagonally upward direction to be respectively coupled to the side part reinforcing frame materials 3ga, 3gb and coupled to lower ends of the pair of support frame materials 4, 5. The movement of the glass substrate G in a diagonally downward direction is regulated with the pair of shift preventing frame materials 3ha, 3hb.

FIG. 7 illustrates a sixth example of the support jig 2 according to the present invention. The support jig 2 illustrated in FIG. 7 further includes a pair of tilt frame materials 3ia, 3ib that are tilted to cross each other between the pair of support frame materials 4, 5, compared to the support jig 2 illustrated in FIG. 2. Of those tilt frame materials, one tilt frame material 3ia is provided so as to couple a bottom part of one support frame material 4 to an upper part of the other support frame material 5, and the other tilt frame material 3ib is provided so as to couple an upper part of one support frame material 4 to a bottom part of the other support frame material 5. The glass substrate G is also supported by the tilt frame materials 3ia, 3ib to be held more stably in a tilted posture.

As illustrated in FIGS. 2 to 7 described above, the support jig 2 supporting the glass substrate G in a tilted state is immersed in an ion exchange solution so that the glass substrate G is subjected to ion exchange treatment.

Fourth, it is preferred that, in the manufacturing method for a tempered glass substrate of the present invention, a value of (length dimension of a part of the tilt support portion held in contact with the glass substrate)/(total of length dimensions of four sides of the glass substrate) be 0.01 or more.

Fifth, it is preferred that, in the manufacturing method for a tempered glass substrate of the present invention, the part of the tilt support portion held in contact with the glass substrate (cross-sectional shape of a part, held in contact with the glass substrate, of a member forming the tilt support portion) have an arc shape with a radius of curvature of 0.1 mm or more.

Sixth, it is preferred that, in the manufacturing method for a tempered glass substrate of the present invention, the glass substrate be arranged so that an end portion on a short side or a long side of the glass substrate extends off from the tilt support portion outwardly by 1 mm or more.

Seventh, it is preferred that, in the manufacturing method for a tempered glass substrate of the present invention, the tilt support portion provided in the support jig be formed of a plurality of members distanced from each other and coupling members for coupling the plurality of members, and the coupling members be arranged in a direction substantially perpendicular to the plurality of members distanced from each other from the viewpoint of alleviating the warping in a center part of the glass substrate during ion exchange treatment.

Eighth, it is preferred that, in the manufacturing method for a tempered glass substrate of the present invention, the glass raw materials be blended so as to obtain a glass substrate having a liquidus temperature of 1,200° C. or less. Herein, the term“liquidus temperature” refers to a temperature at which crystals of glass are deposited after glass powder that is obtained by pulverizing glass, passes through a standard 30-mesh sieve (sieve opening: 500 μm), and remains on a 50-mesh sieve (sieve opening: 300 μm) is placed in a platinum boat and then kept for 24 hours in a gradient heating furnace.

Ninth, it is preferred that, in the manufacturing method for a tempered glass substrate of the present invention, the glass raw materials be blended so as to obtain a glass substrate having a liquidus viscosity of 10^{4.0} dPa·s or more. Herein, the term “liquidus viscosity” refers to a viscosity of glass at a liquidus temperature. It should be noted that as the liquidus viscosity is higher and the liquidus temperature is lower, the devitrification resistance becomes more satisfactory and the formability of the glass substrate becomes more satisfactory.

Tenth, it is preferred that, in the manufacturing method for a tempered glass substrate of the present invention, the glass raw materials be blended so as to obtain a glass composition that comprises, in terms of mol %, 40 to 80% of SiO₂, 5 to 15% of Al₂O₃, 0 to 8% of B₂O₂, 0 to 10% of Li₂O, 0 to 20% of Na₂O, 0 to 20% of K₂O, 0 to 10% of MgO, and 8 to 16.5% of Al₂O₃+MgO, has a molar ratio (Li₂O+Na₂O+K₂O)/Al₂O₃ of from 1 to 3, a molar ratio Na₂O/Al₂O₃ of from 1 to 3, and a molar ratio MgO/Al₂O₃ of from 0 to 1, and is substantially free of As₂O₃, PbO, and F. Herein, the term “Al₂O₃+MgO” refers to the total content of Al₂O₃ and MgO. The term “Li₂O+Na₂O+K₂O” refers to the total content of Li₂O, Na₂O, and K₂O.

Eleventh, it is preferred that, in the manufacturing method for a tempered glass substrate of the present invention, the forming the molten glass into a sheet shape be performed by an overflow down-draw method. With this, an unpolished glass substrate having high surface accuracy can be formed.

Twelfth, it is preferred that, in the manufacturing method for a tempered glass substrate of the present invention, the ion exchange treatment be performed with respect to a glass substrate having a residual stress difference between opposing surfaces of 10 MPa or less.

Thirteenth, it is preferred that, in the manufacturing method for a tempered glass substrate of the present invention, the ion exchange treatment be performed so that the tempered glass substrate has a compressive stress value in a surface of 300 MPa or more and a depth of layer of 10 μm or more. Herein, the term “compressive stress value in a surface” and the term “depth of layer” refer to values calculated on the basis of the number of interference fringes observed when a sample is observed using a surface stress meter (for example, FSM-6000 manufactured by TOSHIBA CORPORATION) and intervals therebetween.

Fourteenth, it is preferred that the manufacturing method for a tempered glass substrate of the present invention be free of a step of polishing the surface of the glass substrate. With this, minute defects caused inevitably by polishing are eliminated, and the mechanical strength of the tempered glass substrate can be enhanced. Further, the manufacturing cost of a tempered glass substrate can be reduced.

Fifteenth, a tempered glass substrate of the present invention is manufactured by the manufacturing method for a tempered glass substrate.

Sixteenth, a tempered glass substrate of the present invention comprises a compressive stress layer in a surface, and has a long side dimension of 1,000 mm or more, a short side dimension of 500 mm or more, and a warping amount of 1% or less. Herein, the term “warping amount” refers to a value calculated by the expression: W/D×100, where W represents a maximum warping amount measured with a 3D shape measurement device and D represents the length of a diagonal line of the glass substrate.

Seventeenth, a manufacturing method for a tempered glass substrate of the present invention comprises: melting glass raw materials to obtain molten glass; forming the molten glass into a sheet shape to obtain a glass substrate having a long side dimension of 1,000 mm or more and a short side dimension of 500 mm or more; preheating the glass substrate at a temperature of from (ion exchange temperature+50)° C. to (ion exchange temperature−50) ° C. for from 10 minutes to 2 hours; and performing ion exchange treatment with respect to the preheated glass substrate to form a compressive stress layer in a surface of the glass substrate.

Eighteenth, a manufacturing method for a tempered glass substrate of the present invention comprises: melting glass raw materials to obtain molten glass; forming the molten glass into a sheet shape to obtain a glass substrate having a long side dimension of 1,000 mm or more and a short side dimension of 500 mm or more; performing ion exchange treatment with respect to the glass substrate to forma compressive stress layer in a surface of the glass substrate, to thereby obtain a tempered glass substrate; and annealing the tempered glass substrate at a temperature of from 100° C. to 400° C. for from 30 minutes to 4 hours.

### BRIEF DESCRIPTION OF DRAWINGS

FIG. 1 is a conceptual diagram illustrating a tilt angle of a glass substrate.

FIG. 2 is a schematic view illustrating an example of a support jig according to the present invention.

FIG. 3 is a schematic view illustrating an example of the support jig according to the present invention.

FIG. 4 is a schematic view illustrating an example of the support jig according to the present invention.

FIG. 5 is a schematic view illustrating an example of the support jig according to the present invention.

FIG. 6 is a schematic view illustrating an example of the support jig according to the present invention.

FIG. 7 is a schematic view illustrating an example of the support jig according to the present invention.

FIG. 8 is a graph showing an example of a temperature profile from a preheating step to an annealing step in a manufacturing method for a tempered glass substrate of the present invention.

FIG. 9 is an explanatory diagram illustrating an experiment in [Example 2] and a conceptual diagram of a glass substrate when viewed from above.

FIG. 10 shows data on simulation results of an experiment in [Experiment 1].

FIG. 11 shows data on simulation results of an experiment in [Experiment 2].

FIG. 12 shows data on simulation results of an experiment in [Experiment 3].

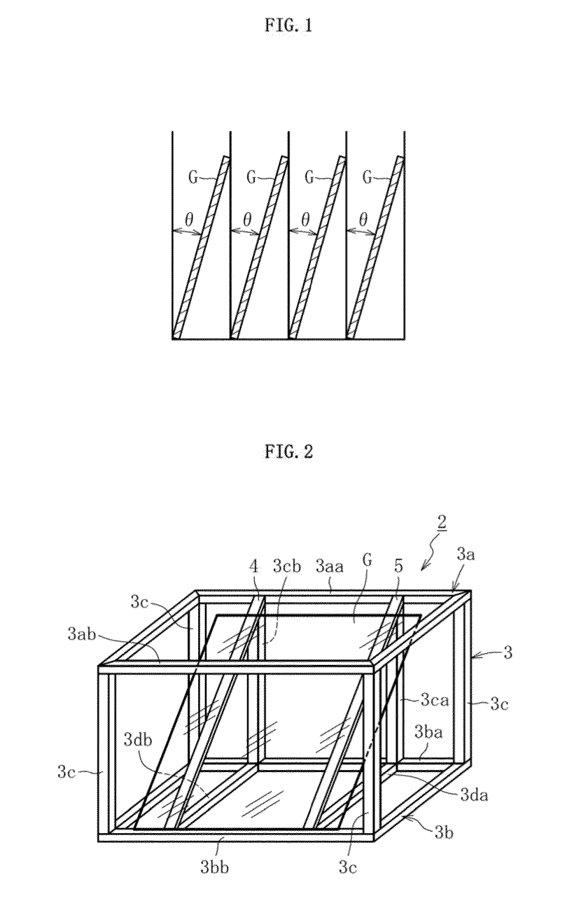

### DESCRIPTION OF EMBODIMENTS

In a manufacturing method for a tempered glass substrate of the present invention, it is preferred that the glass raw materials be loaded in a continuous melting furnace, be melted, for example, at from 1,500° C. to 1,600° C., and be fined, and the molten glass be formed into a sheet shape to obtain a glass substrate having a long side dimension of 1,000 mm or more, a short side dimension of 500 mm or more, and a thickness of 0.6 mm or less, and it is preferred that the glass substrate be annealed during formation as needed.

It is preferred that, in the manufacturing method for a tempered glass substrate of the present invention, the glass raw materials be blended so as to obtain a glass substrate having a density of preferably 2.55 g/cm³ or less, more preferably 2.52 g/cm³ or less, more preferably 2.5 g/cm³ or less, more preferably 2.46 g/cm³ or less, more preferably 2.44 g/cm³ or less, particularly preferably 2.42 g/cm³ or less. A lower density enables weight saving of the glass substrate. Herein, the “density” can be measured by, for example, a well-known Archimedes method. It should be noted that the density may be decreased by increasing the content of SiO₂, P₂O₅, or B₂O₃ or decreasing the content of an alkali metal oxide, an alkaline earth metal oxide, ZnO, ZrO₂, or TiO₂.

It is preferred that, in the manufacturing method for a tempered glass substrate of the present invention, the glass raw materials be blended so as to obtain a glass substrate having a strain point of preferably 500° C. or more, more preferably 520° C. or more, more preferably 550° C. or more, particularly preferably 570° C. or more. A higher strain point brings about higher heat resistance, and the disappearance of the compressive stress layer due to the high-temperature heat treatment is less liable to occur. Further, as the strain point is higher, stress relaxation hardly occurs in the ion exchange treatment. The strain point may be increased by increasing the content of an alkaline earth metal oxide, Al₂O₃, ZrO₂, or P₂O₅ or decreasing the content of an alkali metal oxide.

It is preferred that, in the manufacturing method for a tempered glass substrate of the present invention, the glass raw materials be blended so as to obtain a glass substrate having a temperature at 10^{2.5} dPa·s of preferably 1,650° C. or less, more preferably 1,610° C. or less, more preferably 1,600° C. or less, more preferably 1,580° C. or less, more preferably 1,550° C. or less, more preferably 1,530° C. or less, more preferably 1,500° C. or less, particularly preferably 1,450° C. or less. With a lower temperature at 10^{2.5} dPa·s, a smaller burden is imposed on glass manufacturing equipment such as a melting furnace, and higher bubble quality of a glass substrate is brought about. With a lower temperature at 10^{2.5} dPa·s, a glass substrate can be manufactured at a lower cost. It should be noted that the temperature at 10^{2.5} dPa·s corresponds to a melting temperature. Accordingly, with a lower temperature at 10^{2.5} dPa·s, glass can be melted at lower temperature. It should be noted that the temperature at 10^{2.5} dPa·s may be reduced by increasing the content of an alkali metal oxide, an alkaline earth metal oxide, ZnO, B₂O₃, or TiO₂ or decreasing the content of SiO₂ or Al₂O₃.

It is preferred that, in the manufacturing method for a tempered glass substrate of the present invention, the glass raw materials be blended so as to obtain a glass substrate having a liquidus temperature of preferably 1,200° C. or less, more preferably 1,150° C. or less, more preferably 1,130° C. or less, more preferably 1,100° C. or less, more preferably 1,075° C. or less, more preferably 1,050° C. or less, more preferably 1,030° C. or less, more preferably 1,010° C. or less, more preferably 1,000° C. or less, more preferably 950° C. or less, more preferably 900° C. or less, particularly preferably 860° C. or less. It should be noted that the liquidus temperature may be decreased by increasing the content of Na₂O, K₂O, or B₂O₃ or decreasing the content of Al₂O₃, Li₂O, MgO, ZnO, TiO₂, or ZrO₂.

It is preferred that, in the manufacturing method for a tempered glass substrate of the present invention, the glass raw materials be blended so as to obtain a glass substrate having a liquidus temperature of preferably 10^{4.0} dPa·s or more, more preferably 10^{4.6} dPa·s or more, more preferably 10^{4.8} dPa·s or more, more preferably 10^{5.0} dPa·s or more, more preferably 10^{5.3} dPa·s or more, more preferably 10^{5.5} dPa·s or more, more preferably 10^{5.7} dPa·s or more, more preferably 10^{6.0} dPa·s or more, particularly preferably 10^{6.2} dPa·s or more. It should be noted that when the liquidus temperature is 1,075° C. or less, and the liquidus viscosity is 10^{4.0} dPa·s or more, a glass substrate can be formed by the overflow down-draw method. It should be noted that the liquidus viscosity may be increased by increasing the content of Na₂O or K₂O or decreasing the content of Al₂O₃, Li₂O, MgO, ZnO, TiO₂, or ZrO₂.

It is preferred that, in the manufacturing method for a tempered glass substrate of the present invention, the glass raw materials be blended so as to obtain a glass substrate having a thermal expansion coefficient within a temperature range of from 30° C. to 380° C. of preferably from 70×10⁻⁷/° C. to 110×10⁻⁷/° C., more preferably from 75×10⁻⁷/° C. to 100×10⁻⁷/° C., more preferably 80×10⁻⁷/° C. to 100×10⁻⁷/° C., particularly preferably 85×10⁻⁷/° C. to 96×10⁻⁷/° C. When the thermal expansion coefficient falls within the range, the thermal expansion coefficient can be easily matched with that of a member such as a metal or an organic adhesive, which can prevent the detachment of the member such as the metal or the organic adhesive. Herein, the “thermal expansion coefficient within a temperature range of from 30° C. to 380° C.” refers to an average value obtained by measurement with a dilatometer. It should be noted that the thermal expansion coefficient may be increased by increasing the content of an alkali metal oxide or an alkaline earth metal oxide, and conversely, may be lowered by reducing the content of the alkali metal oxide or the alkaline earth metal oxide.

It is preferred that, in the manufacturing method for a tempered glass substrate of the present invention, the glass raw materials be blended so as to obtain a glass substrate having a Young's modulus of preferably 65 GPa or more, more preferably 69 GPa or more, more preferably 71 GPa or more, more preferably 75 GPa or more, particularly preferably 77 GPa or more. As the Young's modulus increases, the tempered glass substrate is less liable to bend. Therefore, when the tempered glass substrate is applied to a blackboard or the like, the amount of deformation upon strong pressing with a pen or a finger reduces, and as a result, the tempered glass substrate is easily prevented from being brought into contact with a liquid crystal element positioned on a back surface of the tempered glass substrate to cause a display defect.

It is preferred that, in the manufacturing method for a tempered glass substrate of the present invention, the glass raw materials be blended so as to obtain a glass composition that comprises 40 to 80% of SiO₂, 5 to 15% of Al₂O₃, 0 to 8% of B₂O₃, 0 to 10% of Li₂O, 0 to 20% of Na₂O, 0 to 20% of K₂O, 0 to 10% of MgO, and 8 to 16.5% of Al₂O₃+MgO in terms of mol %, has a molar ratio (Li₂O+Na₂O+K₂O)/Al₂O₃ of from 1.4 to 3, a molar ratio Na₂O/Al₂O₃ of from 1 to 3, and a molar ratio MgO/Al₂O₃ of from 0 to 1, and is substantially free of As₂O₃, PbO, and F. The reasons for limiting the content range of each component as described above are described below. It should be noted that, in the description of the content range of each component, the expression “%” refers to “mol %”.

SiO₂ is a component that forms a network of a glass. The content of SiO₂ is from 40 to 80%, from 45 to 80%, from 55 to 75%, from 60 to 75%, particularly from 60 to 70%. When the content of SiO₂ is too large, the meltability and the formability are liable to lower, and the thermal expansion coefficient becomes too low, with the result that it becomes difficult to match the thermal expansion coefficient with those of peripheral materials. On the other hand, when the content of SiO₂ is too small, vitrification does not occur easily. Further, the thermal expansion coefficient becomes too high, and the thermal shock resistance of the tempered glass substrate is liable to lower.

Al₂O₃ is a component that enhances ion exchange performance, and is also a component that increases a strain point and a Young's modulus. The content of Al₂O₃ is preferably from 5 to 15%. When the content of Al₂O₃ is too large, a devitrified crystal is liable to be deposited in the glass and it becomes difficult to form the glass by an overflow down-draw method. Further, the thermal expansion coefficient becomes too low, with the result that it becomes difficult to match the thermal expansion coefficient with those of peripheral materials. In addition, the viscosity at high temperature rises, and the meltability is liable to lower. On the other hand, when the content of Al₂O₃ is too small, sufficient ion exchange performance is not exhibited in some cases. Accordingly, the lower limit range of the content of Al₂O₃ is preferably 6% or more, more preferably 7% or more, more preferably 8% or more, more preferably 9% or more, particularly preferably 10% or more, and the upper limit range thereof is preferably 14% or less, more preferably 13% or less, more preferably 12% or less, even more preferably 11.5% or less.

B₂O₃ is a component that lowers the viscosity at high temperature and the density and enhances the ion exchange performance, in particular, a compressive stress value. B₂O₃ further has effects of stabilizing glass so as to prevent a crystal from being easily deposited, and lowering the liquidus temperature. However, when the content of B₂O₃ is too large, through ion exchange treatment, coloring in the surface of glass called weathering may occur, water resistance may lower, and the depth of layer is liable to decrease. Accordingly, the content of B₂O₃ is preferably from 0 to 8%, more preferably 0 to 5%, more preferably 0 to 3%, more preferably 0 to 2%, particularly preferably 0 to 1%.

Li₂O is an ion exchange component, and is also a component that lowers the viscosity at high temperature to increase the meltability and the formability. Further, Li₂O is a component that increases the Young's modulus. Further, Li₂O has a high effect of increasing the compressive stress value among alkali metal oxides. However, when the content of Li₂O is too large, the liquidus viscosity lowers and the glass is liable to be devitrified. Further, the thermal expansion coefficient becomes too high, and the thermal shock resistance of the tempered glass substrate lowers, with the result that it becomes difficult to match the thermal expansion coefficient with those of peripheral materials. Further, when the viscosity at low temperature excessively lowers and stress relaxation easily occurs, the compressive stress value may lower contrarily. Therefore, the content of Li₂O is preferably from 0 to 10%, more preferably from 0 to 5%, more preferably from 0 to 1%, more preferably from 0 to 0.5%, particularly preferably from 0 to 0.1%. It is most preferred that the content of Li₂O be substantially zero, that is, be limited to less than 0.01%.

Na₂O is an ion exchange component, and is also a component that lowers the viscosity at high temperature to increase the meltability and the formability. Further, Na₂O is also a component that improves the devitrification resistance. The content of Na₂O is preferably from 5 to 20%, preferably from 8 to 20%, more preferably from 8.5 to 20%, more preferably from 10 to 18%, more preferably from 10 to 16%, more preferably from 11 to 16%, more preferably from 12 to 16%, particularly preferably from 13 to 16%. When the content of Na₂O is too large, the thermal expansion coefficient becomes too high, and the thermal shock resistance of the tempered glass substrate lowers, with the result that it becomes difficult to match the thermal expansion coefficient with those of peripheral materials. Further, there is a tendency that the strain point excessively lowers, and the glass composition loses its component balance, with the result that the devitrification resistance lowers contrarily. On the other hand, when the content of Na₂O is too small, the meltability lowers, the thermal expansion coefficient lowers, and the ion exchange performance is liable to lower.

K₂O has an effect of promoting ion exchange, and has a high effect of increasing a depth of layer among alkali metal oxides. Further, K₂O has an effect of lowering the viscosity at high temperature to increase the meltability and the formability. K₂O is also a component that improves the devitrification resistance. However, when the content of K₂O is too large, the thermal expansion coefficient becomes high, and the thermal shock resistance of the tempered glass substrate lowers, with the result that it becomes difficult to match the thermal expansion coefficient with those of peripheral materials. Further, there is a tendency that the strain point excessively lowers, and the glass composition loses its balance, with the result that the devitrification resistance lowers contrarily. Thus, the upper limit range of the content of K₂O is preferably 20% or less, more preferably 10% or less, more preferably 8% or less, more preferably 6% or less, more preferably 5% or less, particularly preferably 4% or less. In the case of adding K₂O, the lower limit range is preferably 0.1% or more, more preferably 0.5% or more, more preferably 1% or more, more preferably 2% or more, particularly preferably 2.5% or more.

When the content of alkali metal oxides R₂O (R represents one or more kinds selected from Li, Na, and K) is too large, the glass is liable to be devitrified. In addition, the thermal expansion coefficient becomes too high, and the thermal shock resistance of the tempered glass substrate lowers, with the result that it becomes difficult to match the thermal expansion coefficient with those of peripheral materials. Further, the strain point excessively lowers, and it becomes difficult to secure a high compressive stress value. Further, the viscosity around the liquidus temperature lowers, and it becomes difficult to secure a high liquidus viscosity in some cases. On the other hand, when the content of R₂O is too small, the ion exchange performance and the meltability are liable to lower. Thus, the content of R₂O is preferably from 10 to 25%, more preferably from 13 to 22%, more preferably from 15 to 20%, particularly preferably from 16.5 to 20%.

The molar ratio K₂O/Na₂O is preferably from 0.1 to 0.8, more preferably from 0.2 to 0.8, more preferably from 0.2 to 0.5, particularly preferably from 0.2 to 0.4. When the molar ratio K₂O/Na₂O decreases, the depth of layer is liable to decrease. In contrast, when the molar ratio K₂O/Na₂O increases, a compressive stress value to be obtained decreases, and the glass composition loses its balance, with the result that glass is liable to be devitrified.

MgO is a component that lowers the viscosity at high temperature to increase the meltability and the formability, or to increase the strain point and the Young's modulus, and has a high effect of improving the ion exchange performance among alkaline earth metal oxides. However, when the content of MgO is high, the density and the thermal expansion coefficient increase, and the glass is liable to be devitrified. Thus, the content of MgO is preferably from 0 to 10%, more preferably from 0 to 6%, particularly preferably from 0 to 4%.

The total content of Al₂O₃ and MgO is preferably from 8 to 16.5%. When the total content of Al₂O₃ and MgO becomes small, the ion exchange performance is liable to lower. In contrast, when the total amount of Al₂O₃ and MgO becomes large, the devitrification resistance and the formability are liable to lower. Accordingly, the total content of Al₂O₃ and MgO is preferably from 8 to 16%, particularly preferably from 8 to 14%.

The molar ratio (Li₂O+Na₂O+K₂O)/Al₂O₃ is preferably from 1 to 3, more preferably from 1.4 to 3, more preferably from 1.5 to 2.5, particularly preferably from 1.8 to 2.5. The molar ratio Na₂O/Al₂O₃ is preferably from 1 to 3, more preferably from 1.2 to 3, particularly preferably from 1.2 to 2.5. The molar ratio MgO/Al₂O₃ is preferably from 0 to 1, more preferably from 0 to 0.7, particularly preferably from 0 to 0.5. With this, the devitrification resistance can be effectively improved.

Besides the above-mentioned components, for example, the following components may be added.

CaO is a component that lowers the viscosity at high temperature to increase the meltability and the formability, or to increase the strain point and the Young's modulus, and has a high effect of improving the ion exchange performance among alkaline earth metal oxides. The content of CaO is preferably from 0 to 6%, more preferably from 0 to 5%, more preferably from 0 to 4%, particularly preferably from 0 to 2%. However, when the content of CaO is high, the density and the thermal expansion coefficient increase, and the glass is liable to be devitrified. In addition, the ion exchange performance is liable to lower.

The total content of MgO and CaO is preferably from 0 to 7%, more preferably from 0 to 6%, more preferably from 0 to 5%, more preferably from 0 to 4%, particularly preferably from 0 to 3%. When the total content of MgO and CaO increases, although the ion exchange performance is enhanced, the devitrification resistance lowers and the density and the thermal expansion coefficient become too high.

SrO and BaO are components that lower the viscosity at high temperature to increase the meltability and the formability, or to increase the strain point and the Young's modulus. The content of SrO is preferably from 0 to 6%, more preferably from 0 to 3%, more preferably from 0 to 1.5%, more preferably from 0 to 1%, more preferably from 0 to 0.5%, particularly preferably from 0 to 0.2%. The content of BaO is preferably from 0 to 3%, more preferably from 0 to 1.5%, more preferably from 0 to 1%, more preferably from 0 to 0.5%, particularly preferably from 0 to 0.2%. When the contents of those components are too large, the ion exchange reaction is inhibited, and in addition, the density and the thermal expansion coefficient increase and glass is liable to be devitrified.

The total content of SrO and BaO is preferably from 0 to 6%, more preferably from 0 to 3%, more preferably from 0 to 2.5%, more preferably from 0 to 2%, more preferably from 0 to 1%, particularly preferably from 0 to 0.2%. With this, the ion exchange performance can be effectively enhanced.

When the content of the alkaline earth metal oxide R′O (R′ represents one or more kinds selected from Mg, Ca, Sr, and Ba) becomes large, the density and the thermal expansion coefficient increase and the devitrification resistance is liable to lower, and in addition, the ion exchange performance is liable to lower. Accordingly, the content of R′O is preferably from 0 to 10%, more preferably from 0 to 8%, more preferably from 0 to 7%, more preferably from 0 to 6%, particularly preferably from 0 to 4%.

ZnO is a component that enhances the ion exchange performance, and has a high effect of increasing the compressive stress value, in particular. Further, ZnO is a component that reduces the viscosity at high temperature without reducing the viscosity at low temperature. However, when the content of ZnO is high, there is a tendency that the glass undergoes phase separation, the devitrification resistance lowers, the density increases, and the depth of layer decreases. Thus, the content of ZnO is preferably from 0 to 6%, more preferably from 0 to 5%, more preferably from 0 to 3%, particularly preferably from 0 to 1%.

When the mass ratio R′O/R₂O becomes large, the devitrification resistance is liable to lower. Accordingly, the mass ratio R′O/R₂O is preferably 0.5 or less, more preferably 0.3 or less, particularly preferably 0.2 or less.

TiO₂ is a component that enhances the ion exchange performance. TiO₂ also has an effect of decreasing the viscosity at high temperature. However, when the content of TiO₂ is too large, glass is liable to be colored and devitrified. Accordingly, the content of TiO₂ is preferably from 0 to 3%, more preferably from 0 to 1%, more preferably from 0 to 0.8%, more preferably from 0 to 0.5%, particularly preferably from 0 to 0.1%.

ZrO₂ has effects of remarkably enhancing the ion exchange performance, and increasing the viscosity around the liquidus viscosity and the strain point. However, when the content of ZrO₂ is too large, the devitrification resistance may lower markedly. Thus, the content of ZrO₂ is preferably from 0 to 10%, more preferably from 0 to 5%, more preferably from 0 to 3%, more preferably from 0.001 to 3%, more preferably from 0.1 to 3%, more preferably from 1 to 3%, particularly preferably from 1.5 to 3%.

From the viewpoint of enhancing the ion exchange performance, it is desired that ZrO₂ and TiO₂ be added in a total content of from 0.1 to 15%. Reagents may be used as a TiO₂ source and a ZrO₂ source, or ZrO₂ and TiO₂ to be contained may derive from impurities contained in glass raw materials or the like.

SnO₂ is a component that enhances the ion exchange performance. However, when the content of SnO₂ becomes large, devitrification caused by SnO₂ is liable to occur or the glass is liable to be colored. Accordingly, the content of SnO₂ is preferably from 0.01 to 6%, more preferably from 0.01 to 3%, particularly preferably from 0.1 to 1%.

P₂O₅ is a component that enhances the ion exchange performance and is a component that increases the depth of layer, in particular. However, when the content of P₂O₅, becomes large, the glass undergoes phase separation, and the water resistance is liable to lower. Thus, the content of P₂O₅ is preferably from 0 to 10%, more preferably from 0 to 3%, more preferably from 0 to 1%, particularly preferably from 0 to 0.5%.

As the fining agent, one kind or two or more kinds selected from the group consisting of As₂O₃, Sb₂O₃, CeO₂, F, Cl, and SO₃ may be added in an amount of from 0 to 3%. In particular, it is desired that SO₃+Cl be used in an amount of from 0.001 to 5%, preferably from 0.001 to 3%. Herein, the term “SO₃+Cl” refers to the total content of SO₃ and Cl.

A rare earth oxide such as Nd₂O₃ or La₂O₃ is a component that enhances the Young's modulus. However, the cost of the raw material itself is high, and when the rare earth oxide is added in a large amount, the devitrification resistance is liable to deteriorate. Thus, the content of the rare earth oxide is preferably from 0 to 3%, more preferably from 0 to 2%, more preferably from 0 to 1%, more preferably from 0 to 0.5%, particularly preferably from 0 to 0.1%.

A transition metal oxide such as CoO₃ or NiO is a component that causes intense coloration of glass to lower the transmittance of a glass substrate. In particular, in the case of using the transition metal oxide in a touch panel display, when the content of the transition metal oxide is large, the visibility of the touch panel display is liable to lower. Accordingly, the content of the transition metal oxide is preferably from 0 to 0.5%, more preferably from 0 to 0.1%, particularly preferably from 0 to 0.05%.

With a view to environmental friendliness, it is preferred that the glass raw materials be substantially free of As₂O₃, PbO, and F. With a view to environmental friendliness, it is also preferred that the glass raw materials be substantially free of PbO and Bi₂O₃. Herein, the phrase “substantially free of” refers to that the mixing at an impurity level is allowed, and specifically to the case where the content thereof is less than 0.1%.

The preferred content range of each component can be appropriately selected to obtain a preferred glass composition range. Of those, an example of a more preferred glass composition range is as described below.

(1) Glass composition comprising, in terms of mol %, 50 to 80% of SiO₂, 8 to 11% of Al₂O₃, 0 to 3% of B₂O₃, 0 to 4% of Li₂O, 8 to 20% of Na₂O, 0 to 7.5% of K₂O, 0 to 6% of CaO, 0 to 6% of MgO, 0 to 6% of SrO, 0 to 6% of BaO, 0 to 6% of ZnO, 8 to 16.5% of Al₂O₃+MgO, and 0 to 7% of CaO+MgO, having a molar ratio (Li₂O+Na₂O+K₂O)/Al₂O₃ of from 1.3 to 2.5, a molar ratio Na₂O/Al₂O₃ of from 1.2 to 3, and a molar ratio MgO/Al₂O₃ of from 0 to 1, and being substantially free of As₂O₃, PbO, F, and BaO.

(2) Glass composition comprising, in terms of mol %, 55 to 75% of SiO₂, 8 to 10% of Al₂O₃, 0 to 2% of B₂O₃, 0 to 4% of Li₂O, 8.5 to 20% of Na₂O, 3.5 to 7.5% of KAO, 0 to 6% of MgO, 0 to 6% of CaO, 0 to 1.5% of SrO, 0 to 1.5% of BaO, 0 to 1% of ZnO, 0 to 0.8% of TiO₂, 0 to 3% of ZrO₂, 8 to 1.6% of MgO+Al₂O₃, and 0 to 7% of MgO+CaO, having a molar ratio (Li₂O+Na₂O+K₂O)/Al₂O₃ of from 1.8 to 2.5, a molar ratio Na₂O/Al₂O₃ of from 1.2 to 3, a molar ratio MgO/Al₂O₃ of from 0 to 1, and a molar ratio K₂O/Na₂O of from 0.2 to 0.5, and being substantially free of As₂O₃, PbO, F, and BaO.

(3) Glass composition comprising, in terms of mol %, 55 to 75% of SiO₂, 8 to 10% of Al₂O₃, 0 to 2% of B₂O₃, 0 to 4% of Li₂O, 10 to 16% of Na₂O, 3.5 to 7.5% of K₂O, 0 to 4% of MgO, 0 to 4% of CaO, 0 to 1% of SrO, 0 to 1% of BaO, 0 to 1% of ZnO, 0 to 0.5% of TiO₂, 0 to 3% of ZrO₂, 0 to 1% of P₂O₅, 8 to 14% of MgO+Al₂O₃, and 0 to 3% of MgO+CaO, having a molar ratio (Li₂O+Na₂O+K₂O)/Al₂O₃ of from 1.8 to 2.5, a molar ratio Na₂O/Al₂O₃ of from 1.2 to 3, a molar ratio MgO/Al₂O₃ of from 0 to 0.5, and a molar ratio K₂O/Na₂O of from 0.2 to 0.4, and being substantially free of As₂O₃, PbO, F, and BaO.

(4) Glass composition comprising, in terms of mol %, 55 to 75% of SiO₂, 8 to 10% of Al₂O₃, 0 to 2% of B₂O₃, 0 to 4% of Li₂O, 11 to 16% of Na₂O, 3.5 to 7.5% of K₂O, 0 to 4% of MgO, 0 to 3% of CaO, 0 to 0.5% of SrO, 0 to 0.5% of BaO, 0 to 1% of ZnO, 0 to 0.5% of TiO₂, 0 to 3% of ZrO₂, 0 to 1% of P₂O₅, 0.01 to 2% of SnO₂, 8 to 1.4% of MgO+Al₂O₃, and 0 to 3% of MgO+CaO, having a molar ratio (Li₂O+Na₂O+K₂O)/Al₂O₃ of from 1.8 to 2.5, a molar ratio Na₂O/Al₂O₃ of from 1.2 to 2.5, a molar ratio MgO/Al₂O₃ of from 0 to 0.5, and a molar ratio K₂O/Na₂O of from 0.2 to 0.4, and being substantially free of As₂O₃, PbO, F, and BaO.

(5) Glass composition comprising, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, 8 to 16.5% of Al₂O₃+MgO, and 0.01 to 5% of Sb₂O₃, having a molar ratio (Li₂O+Na₂O+K₂O)/Al₂O₃ of from 1.4 to 3, a molar ratio Na₂O/Al₂O₃ of from 1 to 3, and a molar ratio MgO/Al₂O₃ of from 0 to 1, and being substantially free of As₂O₃, PbO, and F.

(6) Glass composition comprising, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, 8 to 16.5% of Al₂O₃+MgO, and 0.001 to 5% of SO₃, having a molar ratio (Li₂O+Na₂O+K₂O)/Al₂O₃ of from 1.4 to 3, a molar ratio Na₂O/Al₂O₃ of from 1 to 3, and a molar ratio MgO/Al₂O₃ of from 0 to 1, and being substantially free of As₂O₃, PbO, and F.

(7) Glass composition comprising, in terms of mol %, 45 to 80% of SiO₂, 8 to 12% of Al₂O₃, 0 to 8% of B₂O₃, 0 to 10% of Li₂O, 5 to 20% of Na₂O, 0.5 to 20% of K₂O, 0 to 6% of CaO, 0 to 6% of MgO, 8 to 16.5% of Al₂O+MgO, 0 to 7% of CaO+MgO, and 0.001 to 10% of SnO₂+Sb₂O₃+SO₃, having a molar ratio (Li₂O+Na₂O+K₂O)/Al₂O₃ of from 1.4 to 3, a molar ratio Na₂O/Al₂O₃ of from 1 to 3, a molar ratio MgO/Al₂O₃ of from 0 to 1, and a molar ratio K₂O/Na₂O of from 0.1 to 0.8, and being substantially free of As₂O₃, PbO, and F.

As a method of forming molten glass into a sheet shape, an overflow down-draw method is preferred. The reason for this is as follows: in the case of the overflow down-draw method, the surface that is to serve as the surface of the glass substrate is formed in a state of a free surface without being brought into contact with the surface of a trough-shaped refractory, which allows for forming of a glass substrate having satisfactory surface quality in an unpolished state. Herein, the “overflow down-draw method” refers to a method comprising causing glass in a molten state to overflow from both sides of a heat-resistant trough-shaped structure, and subjecting the overflowing molten glasses to down-draw downward while the molten glasses are joined at the lower end of the trough-shaped structure, to thereby manufacture a glass substrate. The structure and material of the trough-shaped structure are not particularly limited as long as the desired dimensions and surface accuracy of the glass substrate can be obtained, and the quality to be used for the glass substrate can be realized. Further, there is no limit to a method of applying a force to the glass substrate so as to perform downward drawing. For example, a method involving bringing a heat-resistant roll having a sufficiently large width into contact with a glass substrate and drawing the glass substrate by rotating the heat-resistant roller in this state may be adopted, or a method involving bringing a plurality of paired heat-resistant rolls into contact with only the vicinity of an end surface of a glass substrate and drawing the glass substrate may be adopted.

As the method of forming molten glass into a sheet shape, various forming methods other than the overflow down-draw method may also be adopted. For example, forming methods such as a down draw method (such as a slot down method or a re-draw method), a float method, a roll out method, and a press method may be adopted.

In the manufacturing method for a tempered glass substrate of the present invention, the glass substrate is formed so as to have a thickness of preferably 0.6 mm or less, more preferably 0.55 mm or less, more preferably 0.5 mm or less, more preferably 0.4 mm or less, particularly preferably 0.3 mm or less. As the thickness of the glass substrate is smaller, the glass substrate can be reduced in weight. It should be noted that, when the glass substrate is formed by the overflow down-draw method, the glass substrate can be reduced in thickness easily.

In the manufacturing method for a tempered glass substrate of the present invention, the glass substrate is formed so as to have a long side dimension of 1,000 mm or more (preferably 1,200 mm or more, more preferably 1,500 mm or more, more preferably 1,800 mm or more, particularly preferably 2,000 mm or more). As the long side dimension of the glass substrate is larger, the glass substrate becomes more suitable for a cover glass for a large-screen TV, a digital signage display, a touch panel display, an electronic blackboard, a solar cell, and the like. It should be noted that, as the long side dimension of the glass substrate is larger, the effects of the present invention become relatively greater.

In the manufacturing method for a tempered glass substrate of the present invention, the glass substrate is formed so as to have a short side dimension of 500 mm or more (preferably 800 mm or more, more preferably 1,000 mm or more, more preferably 1,200 mm or more, particularly preferably 1,500 mm or more). As the short side dimension of the glass substrate is larger, the glass substrate becomes more suitable for a cover glass for a large-screen TV, a digital signage display, a touch panel display, an electronic blackboard, a solar cell, and the like. It should be noted that, as the short side dimension of the glass substrate is larger, the effects of the present invention become relatively greater.

It is preferred that the manufacturing method for a tempered glass substrate of the present invention be free of a step of polishing the surface (in particular, an effective surface) of the glass substrate. The average surface roughness (Ra) of an unpolished surface is preferably 10 Å or less, more preferably 5 Å or less, particularly preferably 2 Å or less. It should be noted that the average surface roughness (Ra) of the surface may be measured by a method in conformity with SEMI D7-94 “FPD Glass Substrate Surface Roughness Measurement Method.” A glass substrate originally has extremely high theoretical strength, but often breaks even under a stress far lower than the theoretical strength. This is because a small flaw called a Griffith flaw is generated in the surface of the glass substrate in a step after forming, such as a polishing step. Thus, when the surface of the tempered glass substrate is left unpolished, the original mechanical strength of the glass substrate is hardly impaired, and the glass substrate is less liable to break. In addition, when the surface of the glass substrate is left unpolished, a polishing step can be omitted, and hence the manufacturing cost of the glass substrate can be reduced. In addition, when the entirety of both surfaces of the glass substrate is left unpolished, the glass substrate is still less liable to undergo breakage. In addition, in order to prevent a situation in which breakage occurs from a cut surface of the glass substrate, the cut surface of the glass substrate may be subjected to chamfering processing or the like. It should be noted that in order to obtain the unpolished surface, it is recommended to form the glass substrate by an overflow down-draw method.

The manufacturing method for a tempered glass substrate of the present invention comprises performing ion exchange treatment in a state in which the glass substrate is tilted to form a compressive stress layer in the surface of the glass substrate.

In the manufacturing method for a tempered glass substrate of the present invention, it is preferred that the ion exchange treatment be performed in a state in which the glass substrate is tilted by from 0.1° to 30° with respect to a vertical direction. In the case where the tilt angle is too small, when a large-size tempered glass substrate is subjected to the ion exchange treatment, the glass substrate is subjected to the ion exchange treatment in a state in which the glass substrate is buckled and deformed due to the own weight, with the result that the warping amount of the tempered glass substrate is liable to increase. Accordingly, the tilt angle is preferably 0.1° or more, more preferably 0.3° or more, more preferably 0.5° or more, more preferably 1° or more, more preferably 1.3° or more, more preferably 1.6° or more, more preferably 2° or more, particularly preferably 3° or more. On the other hand, when the tilt angle becomes too large, the number of the glass substrates to be treated in one ion exchange treatment decreases, and the manufacturing efficiency of the tempered glass substrate is liable to decrease. Accordingly, the tilt angle is preferably 30° or less, more preferably 25° or less, more preferably 20° or less, more preferably 15° or less, particularly preferably 12° or less.

It is preferred that, in the manufacturing method for a tempered glass substrate of the present invention, the ion exchange treatment be performed in a state in which the glass substrate is tilted through use of a support jig including a tilt support portion. The tilt support portion of the support jig makes it easy for the glass substrate to be tilted and allows the glass substrate to hold a tilted posture easily.

In the manufacturing method for a tempered glass substrate of the present invention, the value of (length dimension of a part of the tilt support portion held in contact with the glass substrate)/(total of length dimensions of four sides of the glass substrate) is preferably 0.01 or more, more preferably 0.1 or more, more preferably 0.3 or more, more preferably 0.5 or more, more preferably 0.7 or more, more preferably 0.9 or more, more preferably 0.95 or more, particularly preferably 1 or more. With this, the glass substrate is less liable to be deformed during the ion exchange treatment, with the result that the warping amount of the tempered glass substrate can be reduced easily. However, when the value is too large, an area in which the glass substrate and the ion exchange solution are brought into contact with each other becomes small, which makes it difficult to perform the ion exchange treatment properly. The value of (length dimension of apart of the tilt support portion held in contact with the glass substrate)/(total of length dimensions of four sides of the glass substrate) is preferably 10 or less, more preferably 8 or less, more preferably 6 or less, more preferably 5 or less, more preferably 4 or less, particularly preferably 3 or less.

It is preferred that, in the manufacturing method for a tempered glass substrate of the present invention, the part of the tilt support portion of the support jig held in contact with the glass substrate have an arc shape. The radius of curvature of the arc shape is preferably 0.1 mm or more, more preferably 0.2 mm or more, more preferably 0.5 mm or more, more preferably 1 mm or more, more preferably 2 mm or more, more preferably 5 mm or more, particularly preferably 10 mm or more. Further, it is preferred that the shape of a member forming the tilt support portion have a cylindrical shape. With this, the contact area with respect to the glass substrate can be reduced easily, and the glass substrate is less liable to be scratched during the ion exchange treatment.

It is preferred that, in the manufacturing method for a tempered glass substrate of the present invention, the glass substrate be arranged so that an end portion on a short side or a long side of the glass substrate extends off from the tilt support portion of the support jig outwardly by 1 mm or more (preferably 2 mm or more, more preferably 5 mm or more, particularly preferably 10 mm or more) during the ion exchange treatment. In the case where the end portion on a short side or a long side of the glass substrate extends off from the tilt support portion of the support jig by less than 1 mm, when the glass substrate is arranged on the support jig, the end portion on a short side or a long side of the glass substrate is brought into contact with the tilt support portion, with the result that the glass substrate is liable to be cracked.

It is preferred that, in the manufacturing method for a tempered glass substrate of the present invention, in the case where the long side dimension of the glass substrate is defined as “L”, at a time of the ion exchange treatment, the glass substrate be arranged on the support jig so that any side of the glass substrate (preferably long side of the glass substrate) is substantially parallel to the tilt support portion, and an end portion of the side to be substantially parallel to the tilt support portion be arranged outwardly by from 0 to 0.5/L (preferably 0.01/L or more, more preferably 0.02/L or more, more preferably 0.03/L or more, more preferably 0.05/L or more, even more preferably 0.1/L or more) from the tilt support portion. With this, during the ion exchange treatment, the warping amount of a center part of the tempered glass substrate can be reduced easily. In contrast, when the end portion of the side to be substantially parallel to the tilt support portion is arranged at a great distance from the tilt support portion, the end portion of the side to be substantially parallel to the tilt support portion is liable to be deformed. Accordingly, the distance of the side to be substantially parallel to the tilt support portion from the tilt support portion is preferably 0.4/L or less, more preferably 0.35/L or less, more preferably 0.3/L or less, particularly preferably 0.2/L or less.

It is preferred that, in the manufacturing method for a tempered glass substrate of the present invention, the tilt support portion provided in the support jig be formed of a plurality of members distanced from each other and coupling members for coupling the plurality of members to each other. Further, it is preferred that the glass substrate be arranged on the support jig so that any side of the glass substrate is substantially perpendicular to the coupling members of the support jig. With this, during the ion exchange treatment, the glass substrate can keep a tilted posture easily, and the warping amount of the center part of the tempered glass substrate can be reduced easily.

It is preferred that, in the manufacturing method for a tempered glass substrate of the present invention, in the case where the short side dimension of the glass substrate is defined as “l”, at a time of the ion exchange treatment, the glass substrate be arranged on the support jig so that any side of the glass substrate (preferably short side of the glass substrate) is substantially parallel to the coupling members, and an end portion of the side to be substantially parallel to the coupling members be arranged so as to extend off outwardly by from 0 to 0.5/l (preferably 0.01/l or more, more preferably 0.02/l or more, more preferably 0.03/l or more, more preferably 0.05/l or more, even more preferably 0.1/l or more) from the coupling members. With this, during the ion exchange treatment, the warping amount of a center part of the tempered glass substrate can be reduced easily. In contrast, when the end portion of the side to be substantially parallel to the coupling members is arranged at a great distance from the coupling members, the end portion of the side to be substantially parallel to the coupling members is liable to be deformed. Accordingly, the distance of the side to be substantially parallel to the coupling members from the coupling members is preferably 0.4/l or less, more preferably 0.35/l or less, more preferably 0.3/l or less, particularly preferably 0.2/l or less.

It is preferred that, in the manufacturing method for a tempered glass substrate of the present invention, the ion exchange treatment be performed so that the tempered glass substrate has a compressive stress value in a surface of 300 MPa or more, more preferably 400 MPa or more, more preferably 500 MPa or more, more preferably 600 MPa or more, more preferably 700 MPa or more, particularly preferably 800 MPa or more. As the compressive stress value increases, the mechanical strength of the tempered glass substrate becomes high. In contrast, when the compressive stress value becomes excessively large, microcracks are liable to be formed in the surface, and further, an internal tensile stress value becomes unreasonably large, with the result that the mechanical strength of the tempered glass substrate may decrease contrarily. Accordingly, it is preferred that the ion exchange treatment be performed so that the tempered glass substrate has a compressive stress value of 1,200 MPa or less, more preferably 1,100 MPa or less, particularly preferably 1,000 MPa or less. It should be noted that the compressive stress value may be increased by increasing the content of Al₂O, TiO₂, ZrO₂, MgO, or ZnO or decreasing the content of SrO or BaO. Further, the compressive stress value may be increased by shortening a time period necessary for immersing the glass substrate in an ion exchange solution or decreasing the temperature of the ion exchange solution.

It is preferred that, in the manufacturing method for a tempered glass substrate of the present invention, the ion exchange treatment be performed so that the tempered glass substrate has a depth of layer of 10 μm or more, preferably 15 μm or more, more preferably 20 μm or more, more preferably 30 μm or more, particularly preferably 40 μm or more. When the depth of layer is larger, the tempered glass substrate is less liable to break even when the tempered glass substrate has a deep flaw. Further, the mechanical strength is less varied. In contrast, it becomes difficult to cut the tempered glass substrate. Accordingly, it is preferred that the ion exchange treatment be performed so that the tempered glass substrate has a depth of layer of 120 μm or less, preferably 80 μm or less, more preferably 70 μm or less, more preferably 60 μm or less, particularly preferably 55 μm or less. It should be noted that the depth of layer may be increased by increasing the content of K₂O or P₂O₅ or decreasing the content of SrO or BaO. Further, the depth of layer may be increased by lengthening a time period necessary for immersing the glass substrate in an ion exchange solution or increasing the temperature of the ion exchange solution.

It is preferred that, in the manufacturing method for a tempered glass substrate of the present invention, the ion exchange treatment be performed with respect to a glass substrate having a residual stress difference between opposing surfaces of 10 MPa or less, preferably 5 MPa or less, more preferably 3 MPa or less, particularly preferably 1 MPa or less. When the ion exchange treatment is performed with respect to a glass substrate having a large strain difference between opposing surfaces, the warping amount of the tempered glass substrate becomes large.

In the manufacturing method for a tempered glass substrate of the present invention, the glass substrate may be directly immersed in an ion exchange solution from room temperature. However, from the viewpoint of reducing the warping amount of the tempered glass substrate, it is preferred to provide a preheating step before immersing the glass substrate in the ion exchange solution. The preheating temperature is preferably (ion exchange temperature+50) ° C. or less, more preferably (ion exchange temperature+40) ° C. or less, more preferably (ion exchange temperature+30) ° C. or less, more preferably (ion exchange temperature+20) ° C. or less, particularly preferably (ion exchange temperature+10) ° C. or less. When the preheating temperature is too high, the preheating step becomes too long, and the manufacturing efficiency of the tempered glass substrate is liable to decrease. In contrast, when the preheating temperature is too low, it is also necessary to decrease the temperature of the ion exchange solution in order to avoid thermal shock, with the result that it becomes difficult to obtain desired tempering characteristics stably. Accordingly, the preheating temperature is preferably (ion exchange temperature−50) ° C. or more, more preferably (ion exchange temperature−40) ° C. or more, more preferably (ion exchange temperature−30) ° C. or more, more preferably (ion exchange temperature−20) ° C. or more, particularly preferably (ion exchange temperature−10) ° C. or more.

The preheating time is preferably 10 minutes or more, more preferably 20 minutes or more, particularly preferably 30 minutes or more. When the preheating time is too short, it becomes difficult to ensure in-plane uniform heating property of the glass substrate, with the result that an in-plane variation of tempering characteristics occurs, and the warping is liable to occur in the tempered glass substrate. In contrast, when the preheating time is too long, the preheating step becomes too long, the manufacturing efficiency of the tempered glass substrate is liable to decrease. Accordingly, the preheating time is preferably 2 hours or less, more preferably 1.5 hours or less, particularly preferably 1 hour or less.

In the preheating step, a temperature increase rate is preferably 50° C./hour or more, more preferably 100° C./hour or more, more preferably 150° C./hour or more, particularly preferably 200° C./hour or more. As the temperature increase rate increases, the preheating step can be shortened. However, when the temperature increase rate is too large, there is a risk in that the glass substrate may break. Accordingly, the temperature increase rate is preferably 500° C./hour or less, more preferably 450° C./hour or less, particularly preferably 400° C./hour or less. It should be noted that the preheating step is preferably performed in a state in which the glass substrate is tilted through use of the support jig. However, the preheating step may be performed in a state in which the glass substrate is arranged in a vertical direction.

After the preheating step, the ion exchange treatment is performed by immersing the glass substrate in the ion exchange solution. A lower limit temperature of the ion exchange solution is preferably (strain point−100) ° C. or less, more preferably (strain point−120) ° C. or less, more preferably (strain point−140) ° C. or less, particularly preferably (strain point−150) ° C. or less. An upper limit temperature of the ion exchange solution is preferably (strain point−250) ° C. or more, more preferably (strain point−220) ° C. or more, particularly preferably (strain point−200) ° C. or more. A time period necessary for immersing the glass substrate in the ion exchange solution is preferably from 2 to 10 hours, particularly preferably from 4 to 8 hours. It is appropriate that, as the conditions for the ion exchange treatment, optimum conditions be selected considering the viscosity characteristics, applications, thickness, internal tensile stress, and the like of the glass substrate. In the ion exchange treatment, when ion exchange of K ions in a KNO₃ molten salt with Na components in the glass substrate is performed, it is possible to form the compressive stress layer efficiently in the surface of the glass substrate.

It is preferred to provide an annealing step after the ion exchange treatment. In the annealing step, a temperature decrease rate from the ion exchange temperature to the annealing temperature is an important factor for reducing the warping of the tempered glass substrate. A lower limit of the temperature decrease rate is preferably 30° C./minute or more, more preferably 50° C./minute or more, more preferably 100° C./minute or more, more preferably 150° C./minute or more, particularly preferably 200° C./minute or more. An upper limit of the temperature decrease rate is preferably 500° C./minute or less, more preferably 440° C./minute or less, particularly preferably 400° C./minute or less. When the temperature decrease rate is too large, there is a risk in that the tempered glass substrate may break. Further, the tempered glass substrate is thermally deformed due to an in-plane temperature variation of the tempered glass substrate, and the thermal deformation may be fixed as warping. In contrast, when the temperature decrease rate is too small, the annealing step becomes too long, and the manufacturing efficiency of the tempered glass substrate is liable to decrease.

The annealing temperature is preferably 100° C. or more, more preferably 150° C. or more, more preferably 200° C. or more, particularly preferably 250° C. or more. When the annealing temperature is too low, it becomes difficult to reduce the warping of the tempered glass substrate, and moreover, the ion exchange solution adhering to the tempered glass substrate cannot be removed easily. In contrast, when the annealing temperature is too high, the tempering characteristics tend to decrease and the warping amount of the tempered glass substrate tends to increase. Accordingly, the annealing temperature is preferably 400° C. or less, more preferably 350° C. or less, particularly preferably 300° C. or less.

A lower limit of the annealing time is preferably 30 minutes or more, particularly preferably 1 hour or more. An upper limit of the annealing time is preferably 5 hours or less, particularly preferably 4 hours or less. When the annealing time is too short, it becomes difficult to ensure in-plane uniform heating property of the tempered glass substrate, and the warping amount of the tempered glass substrate tends to increase. In contrast, when the annealing time is too long, the annealing step becomes too long, and the manufacturing efficiency of the tempered glass substrate is liable to decrease. It should be noted that, although the annealing step is performed in a state in which the glass substrate is tilted through use of the support jig, the annealing step may be performed in a state in which the glass substrate is arranged in a vertical direction.

The tempered glass substrate may be taken out to a room temperature environment after the annealing step and cooled rapidly. However, there is a risk in that excessively rapid cooling may increase the warping amount of the tempered glass substrate. Accordingly, the temperature decrease rate after the annealing step is preferably 400° C./hour or less, more preferably 300° C./hour or less, more preferably 200° C./hour or less, more preferably 100° C./hour or less, more preferably 80° C./hour or less, particularly preferably 50° C./hour or less. In contrast, when the temperature decrease rate after the annealing step is too small, the annealing step becomes too long, and the manufacturing efficiency of the tempered glass substrate is liable to decrease.

FIG. 8 is a graph showing an example of a temperature profile from the preheating step to the annealing step in the manufacturing method for a tempered glass substrate of the present invention. Steps A and B illustrated in FIG. 8 represent the preheating step. Step A represents a state in which the temperature increases from room temperature to the preheating temperature, and Step B represents a state in which the preheating temperature is kept for a predetermined time period. Step C represents an ion exchange temperature and an ion exchange time. Steps D and E represent the annealing step. Step D represents a state in which the temperature decreases to the annealing temperature, and Step E represents a state in which the annealing temperature is kept for a predetermined time period. Step F represents a state in which the temperature decreases to room temperature after the annealing step.

In the manufacturing method for a tempered glass substrate of the present invention, the glass substrate may be cut to a predetermined size before the ion exchange treatment but is preferably cut to a predetermined size after the ion exchange treatment because manufacturing cost can be reduced.

A tempered glass substrate of the present invention is manufactured by the above-mentioned manufacturing method for a tempered glass substrate. Further, the tempered glass substrate of the present invention comprises a compressive stress layer in a surface and has a long side dimension of 1,000 mm or more, a short side dimension of 500 mm or more, and a warping amount of 1% or less. Herein, the technical features (preferred configurations, effects, etc.) of the tempered glass substrate of the present invention partially overlap those of the manufacturing method for a tempered glass substrate of the present invention. Thus, the descriptions of the overlapping portions are omitted.

In the tempered glass substrate of the present invention, the warping amount is preferably 1 or less, more preferably 0.8% or less, more preferably 0.5% or less, more preferably 0.3% or less, more preferably 0.2% or less, more preferably 0.1% or less, more preferably 0.05% or less, particularly preferably 0.03% or less. When the warping amount becomes large, entrapment of air may occur when the tempered glass substrate is bonded onto a display, and the tempered glass substrate is liable to peel off after the bonding.

### Example 1

The present invention is hereinafter described based on Examples. It should be noted that the present invention is by no means limited to Examples. Examples are merely illustrative.

Tables 1 to 3 show each glass composition and characteristics of the tempered glass substrate according to the present invention. It should be noted that “Unmeasured” in the table means that measurement has not yet been performed.

TABLE 1

| | | No. 1 | No. 2 | No. 3 | No. 4 | No. 5 |
|---|---|---|---|---|---|---|
| Glass | SiO₂ | 70.9 | 73.9 | 73.8 | 67.6 | 66.1 |
| composition | Al₂O₃ | 9.7 | 8.7 | 8.7 | 8.5 | 8.5 |
| (mol %) | Li₂O | 4.8 | — | — | 4.1 | 4.1 |
| | Na₂O | 9.7 | 13.0 | 8.7 | 8.5 | 8.5 |
| | K₂O | 4.8 | 4.3 | 8.7 | 3.7 | 3.7 |
| | MgO | — | — | — | 6.0 | 6.0 |
| | ZnO | — | — | — | 1.5 | 3.0 |
| | SnO₂ | 0.1 | 0.1 | 0.1 | 0.1 | 0.1 |

| | | | | | |
|---|---|---|---|---|---|
| Density (g/cm³) | 2.42 | 2.41 | 2.41 | 2.46 | 2.50 |
| Ps (° C.) | 455 | 491 | 497 | 493 | 495 |
| Ta (° C.) | 499 | 538 | 545 | 538 | 540 |
| Ts (° C.) | 722 | 775 | 791 | 768 | 762 |
| 10⁴ dPa · s (° C.) | 1,136 | 1,215 | 1,249 | 1,156 | 1,138 |
| 10³ dPa · s (° C.) | 1,370 | 1,456 | 1,494 | 1,363 | 1,338 |
| 10^{2.5} dPa · s (° C.) | 1,517 | 1,610 | 1,650 | 1,493 | 1,466 |
| Thermal expansion | 96 | 91 | 93 | 88 | 89 |
| coefficient (×10⁻⁷/° C.) | | | | | |
| Liquidus temperature (° C.) | 940 | 882 | 967 | 1,008 | 1,038 |
| logηTL | 5.3 | 6.3 | 5.8 | 5.0 | 4.7 |
| Compressive stress (MPa) | 514 | 517 | 349 | 833 | 895 |
| Depth of layer (μm) | 31 | 42 | 57 | 17 | 15 |
| Young's modulus (GPa) | 74 | 69 | 67 | 77 | 77 |
| Rigidity modulus (GPa) | 31 | 29 | 28 | 32 | 32 |

TABLE 2

| | | No. 6 | No. 7 | No. 8 | No. 9 | No. 10 |
|---|---|---|---|---|---|---|
| Glass | SiO₂ | 66.9 | 65.4 | 66.9 | 66.4 | 62.3 |
| composition | Al₂O₃ | 8.5 | 8.5 | 8.4 | 8.6 | 8.4 |
| (mol %) | ZnO | 1.5 | 3.0 | — | — | — |
| | Na₂O | 8.5 | 8.5 | 11.6 | 7.6 | 16.0 |
| | Li₂O | 4.1 | 4.1 | — | — | — |
| | K₂O | 3.7 | 3.7 | 4.2 | 7.5 | 3.5 |
| | ZrO₂ | — | — | 1.3 | 2.2 | 2.1 |
| | TiO₂ | 0.7 | 0.7 | — | — | — |
| | B₂O₃ | — | — | 1.9 | 1.9 | 1.9 |
| | MgO | 6.0 | 6.0 | 3.3 | 3.3 | 3.3 |
| | CaO | — | — | 2.3 | 2.4 | 2.4 |
| | SnO₂ | 0.1 | 0.1 | 0.1 | 0.1 | 0.1 |

| | | | | | |
|---|---|---|---|---|---|
| Density (g/cm³) | 2.47 | 2.51 | 2.49 | 2.50 | 2.54 |
| Ps (° C.) | 496 | 498 | 544 | 574 | 529 |
| Ta (° C.) | 540 | 541 | 589 | 623 | 570 |
| Ts (° C.) | 761 | 755 | 812 | 867 | 773 |
| 10⁴ dPa · s (° C.) | 1,140 | 1,127 | 1,205 | 1,253 | 1,122 |
| 10³ dPa · s (° C.) | 1,344 | 1,325 | 1,406 | 1,447 | 1,300 |
| 10^{2.5} dPa · s (° C.) | 1,473 | 1,451 | 1,534 | 1,570 | 1,417 |
| Thermal expansion | 89 | 89 | 90 | 89 | 100 |
| coefficient (×10⁻⁷/° C.) | | | | | |
| Liquidus temperature (° C.) | 1,009 | 1,032 | 945 | 1,075 | 855 |
| logηTL | 4.9 | 4.6 | 6.0 | 5.3 | 6.4 |
| Compressive stress (MPa) | 845 | 902 | 819 | 638 | 837 |
| Depth of layer (μm) | 17 | 15 | 44 | 55 | 44 |
| Young's modulus (GPa) | 77 | 78 | Unmeasured | Unmeasured | 75 |
| Rigidity modulus (GPa) | 32 | 33 | Unmeasured | Unmeasured | 30 |

TABLE 3

| | | No. 11 | No. 12 |
|---|---|---|---|
| Glass composition (mol %) | SiO₂ | 77.1 | 73.9 |
| | Al₂O₃ | 5.7 | 8.7 |
| | Na₂O | 8.6 | 4.3 |
| | Li₂O | 4.3 | 4.3 |
| | K₂O | 4.3 | 8.7 |
| | SnO₂ | — | 0.1 |

| | | |
|---|---|---|
| Density (g/cm³) | 2.39 | 2.40 |
| Ps (° C.) | 437 | 476 |
| Ta (° C.) | 482 | 523 |
| Ts (° C.) | 704 | 767 |
| 10⁴ dPa · s (° C.) | 1,114 | 1,212 |
| 10³ dPa · s (° C.) | 1,348 | 1,457 |
| 10^{2.9} dPa · s (° C.) | 1,501 | 1,611 |
| Thermal expansion coefficient (×10⁻⁷/° C.) | 88 | 89 |
| Liquidus temperature (° C.) | 815 | 1,013 |
| logηTL | 6.2 | 5.2 |
| Compressive stress (MPa) | 325 | 324 |
| Depth of layer (μm) | 36 | 39 |
| Young's modulus (GPa) | 71 | 70 |
| Rigidity modulus (GPa) | 30 | 30 |

Each sample in the tables was produced as described below. First, glass raw materials were blended so as to have the glass composition in the tables, and melted at 1,580° C. for 8 hours using a platinum pot. After that, the molten glass was poured onto a carbon sheet so as to be formed into a sheet shape. The resultant glass substrate was evaluated for various characteristics.

The density is a value obtained through measurement by a well-known Archimedes method.

The strain point Ps and the annealing point Ta are values obtained through measurement based on a method of ASTM C336.

The softening point Ts is a value obtained through measurement based on a method of ASTM C338.

The temperatures at 10^{4.0} dPa·s, 10^{3.0} dPa·s, and 10^{2.5} dPa·s are values obtained through measurement by a platinum sphere pull up method.

The thermal expansion coefficient α is a value obtained through measurement of an average value in the temperature range of from 30 to 380° C. using a dilatometer.

The liquidus temperature is a value obtained through measurement of a temperature at which crystals of glass are deposited after glass powder that is obtained by pulverizing glass, passes through a standard 30-mesh sieve (sieve opening: 500 μm), and remains on a 50-mesh sieve (sieve opening: 300 μm) is placed in a platinum boat and then kept for 24 hours in a gradient heating furnace.

The liquidus viscosity log ηTL (dPa·s) refers to a value of a viscosity of glass at the liquidus temperature obtained through measurement by a platinum sphere pull up method.

The Young's modulus and the rigidity modulus are values obtained through measurement by a resonance method.

As is apparent from Tables 1 to 3, Samples Nos. 1 to 12 had a density of 2.54 g/cm³ or less, a thermal expansion coefficient of from 88 to 100×10⁻⁷/° C., a liquidus viscosity of 10^{4.6} dPa·s or more, and a temperature at a liquidus viscosity of 10^{2.5} dPa·s of 1,650° C. or less, and hence were suitable as materials for a tempered glass substrate.

Subsequently, both surfaces of each sample were subjected to optical polishing. After that, ion exchange treatment was performed by immersing Samples Nos. 1 to 7, 11, and 12 in a KNO₃ solution at 430° C. for 4 hours, and immersing Sample Nos. 8 to 10 in a KNO₃ solution at 460° C. for 6 hours. It should be noted that the ion exchange treatment was performed in a state in which each sample was tilted by 5° through use of a predetermined support jig. After ion exchange treatment was performed, the surfaces of each of the samples were washed, and then the compressive stress values and depths of layer in the surfaces were calculated on the basis of the number of interference fringes observed using a surface stress meter (FSM-6000 manufactured by TOSHIBA CORPORATION) and intervals therebetween. In the calculation, the refractive index and optical elastic constant of each of the samples were defined as 1.53 and 28 [(nm/cm)/MPa], respectively. It should be noted that the glass composition in the surface layer differs microscopically between the glass substrate (non-tempered glass substrate) and the tempered glass substrate, but when observed as a whole, the glass composition does not differ substantially.

As is apparent from Tables 1 to 3, Sample Nos. 1 to 12 had a compressive stress value of 324 MPa or more and a depth of layer of 15 μm or more.

It should be noted that, in the foregoing, for convenience of the description of the present invention, the glass substrate was formed by pouring, and then subjected to optical polishing before the ion exchange treatment. In the case of carrying out the present invention on an industrial scale, it is desired that the glass substrate be formed by the overflow down-draw method or the like, and the ion exchange treatment be performed in a state in which both the surfaces of the glass substrate are unpolished.

### Example 2

The influence of the tilt angle of a glass substrate, the position of a tilt support portion, and the position of a coupling member on the warping amount of a tempered glass substrate was investigated through use of Sample No. 10 of [Example 1].

### Experiment 1

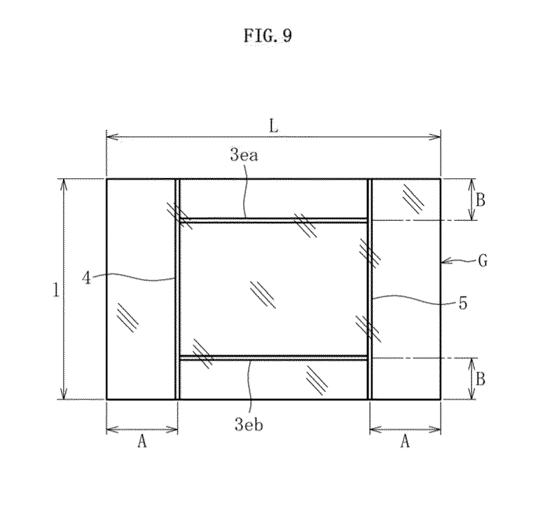

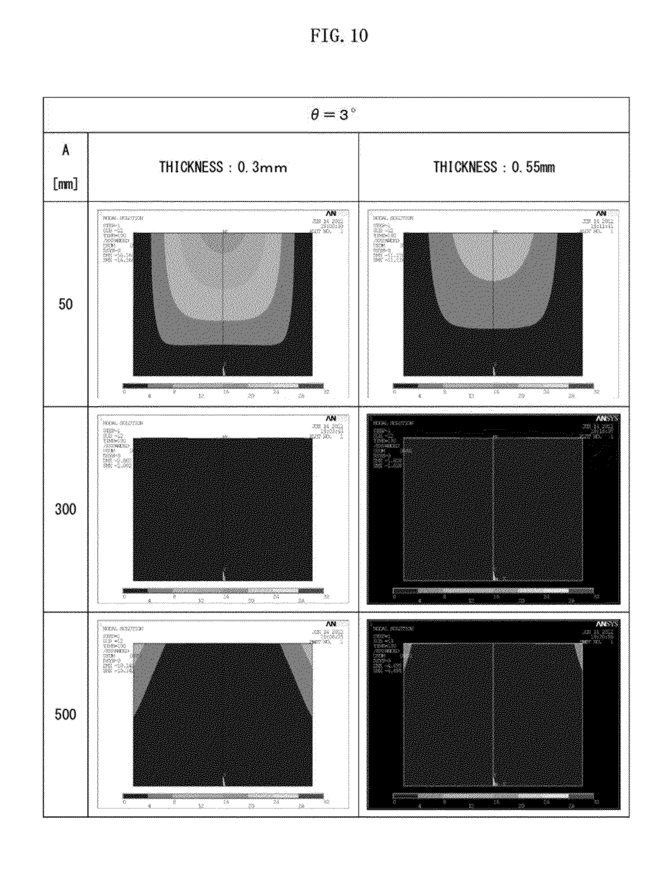

First, the warping amount of each tempered glass substrate (long side dimension of 1,500 mm×short side dimension of 1,200 mm×thickness of 0.3 mm; long side dimension of 1,500 mm×short side dimension of 1,200 mm×thickness of 0.5 mm) was simulated through use of a support jig (Type A) similar to the support jig illustrated in FIG. 2. FIG. 9 is an explanatory view illustrating the experiment of [Example 2], and a conceptual view of a glass substrate G when viewed from above. As illustrated in FIG. 9, the long side dimension of the glass substrate G was defined as “L”, and the short side dimension of the glass substrate was defined as “l”. The interval between an end portion on the short side (which may be the long side; the same applies hereinafter) of the glass substrate G and a pair of support frame materials 4, 5 of a tilt support portion was defined as “A”. It should be noted that the interval A between the end portion on the short side (end portion on the left side of the figure) of the glass substrate G and the support frame material 4 on one side of the tilt support portion was set to be equal to the interval A between the end portion on the short side (end portion on the right side of the figure) of the glass substrate G and the support frame material 5 on the other side of the tilt support portion. Further, in FIG. 9, an interval between an end portion on the long side (which may be the short side; the same applies hereinafter) of the glass substrate G and coupling frame materials 3ea, 3eb is defined as “B”. However, in this experiment, the support frame materials 4, 5 of the tilt support portion not including the coupling frame materials are used. Table 4 and FIG. 10 show the results of the simulation.

TABLE 4

| | | | | | | | Maximum |
|---|---|---|---|---|---|---|---|
| | Thickness | L | l | | A | B | bent amount |
| | [mm] | [mm] | [mm] | θ ° | [mm] | [mm] | [mm] |
| Type A | 0.3 | 1,500 | 1,200 | 3 | 50 | — | 18.2 |
| | 0.3 | 1,500 | 1,200 | 3 | 300 | — | 2.8 |
| | 0.3 | 1,500 | 1,200 | 3 | 500 | — | 10.1 |
| | 0.55 | 1,500 | 1,200 | 3 | 50 | — | 11.2 |
| | 0.55 | 1,500 | 1,200 | 3 | 300 | — | 1.8 |
| | 0.55 | 1,500 | 1,200 | 3 | 500 | — | 4.7 |
| Type B | 0.3 | 1,500 | 1,200 | 10 | 50 | 100 | 2.7 |
| | 0.3 | 1,500 | 1,200 | 10 | 300 | 100 | 7.4 |
| | 0.3 | 1,500 | 1,200 | 10 | 500 | 100 | 28.5 |
| | 0.55 | 1,500 | 1,200 | 10 | 50 | 100 | 2.3 |
| | 0.55 | 1,500 | 1,200 | 10 | 300 | 100 | 2.7 |
| | 0.55 | 1,500 | 1,200 | 10 | 500 | 100 | 9.4 |
| Type B | 0.3 | 1,500 | 1,200 | 10 | 50 | 300 | 4.7 |
| | 0.3 | 1,500 | 1,200 | 10 | 300 | 300 | 7.5 |
| | 0.3 | 1,500 | 1,200 | 10 | 500 | 300 | 28.4 |
| | 0.55 | 1,500 | 1,200 | 10 | 50 | 300 | 2.4 |
| | 0.55 | 1,500 | 1,200 | 10 | 300 | 300 | 3 |
| | 0.55 | 1,500 | 1,200 | 10 | 500 | 300 | 10.2 |

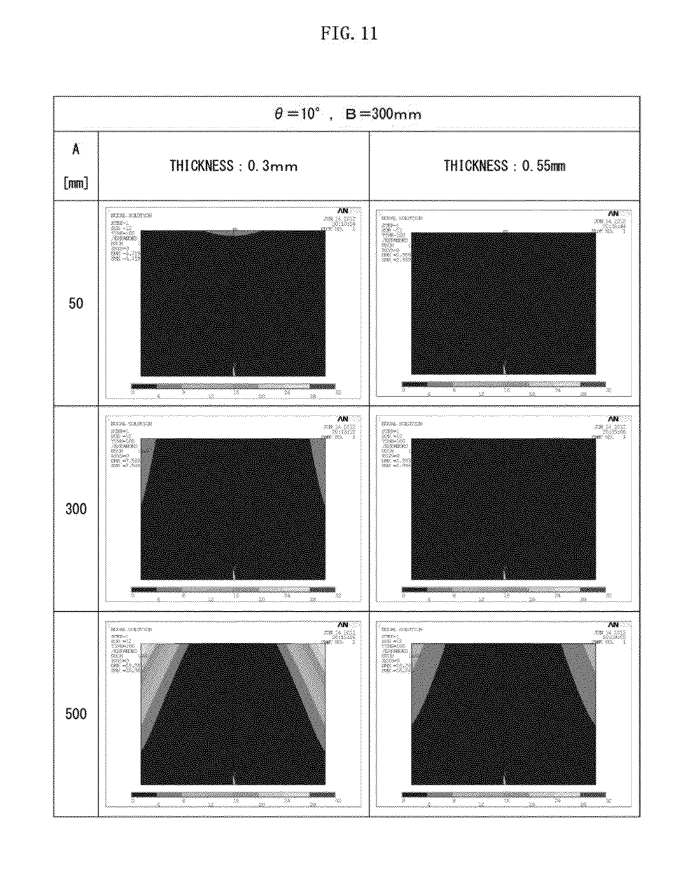

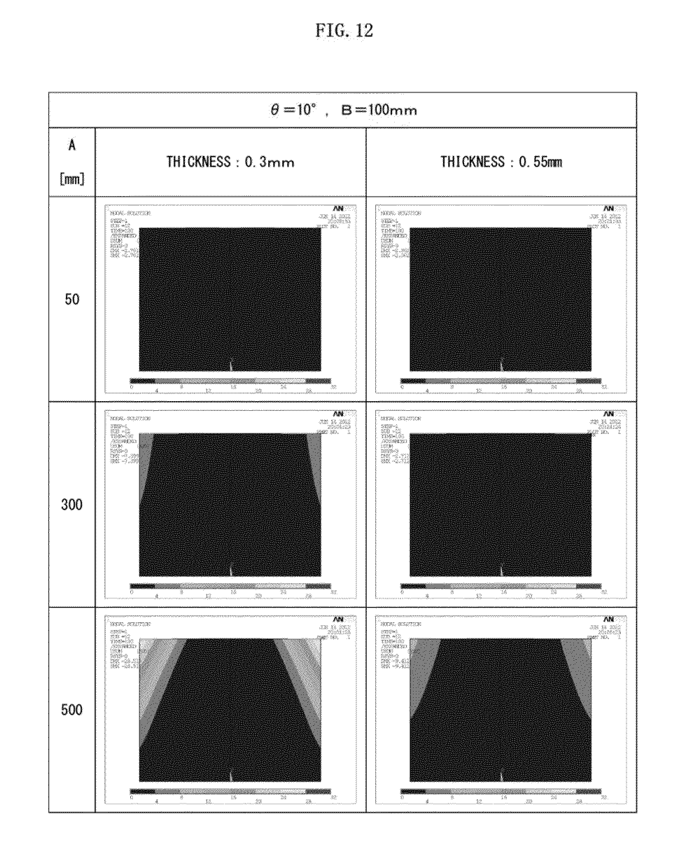

As is apparent from Table 4 and FIG. 10, it is understood that, in the case where the ion exchange treatment is performed in a state in which the glass substrate is tilted, the warping amount can be reduced to within a predetermined range even when the glass substrate is large and thin. It should be noted that indices colored in 8 stages in the order of dark blue, blue, green, yellow, and red are arranged in a lateral direction in a straight line from the left side to the right side below each of 6 graphics illustrated in FIG. 10. Numerical values: 0, 4, 8, 12, 16, 20, 24, 28, and 32 are shown at an equal interval from the left side to the right side below the indices arranged in a straight line (the same applies to FIGS. 11 and 12 described later). Those numerical values represent tensile stress values (MPa). When the 6 graphics of FIG. 10 are checked with reference to the indices, a tensile stress exceeding 24 MPa does not occur in any of the graphics, and most of the regions show a low tensile stress value. This means that the warping amount of the tempered glass substrate is small in all the 6 graphics.

### Experiment 2

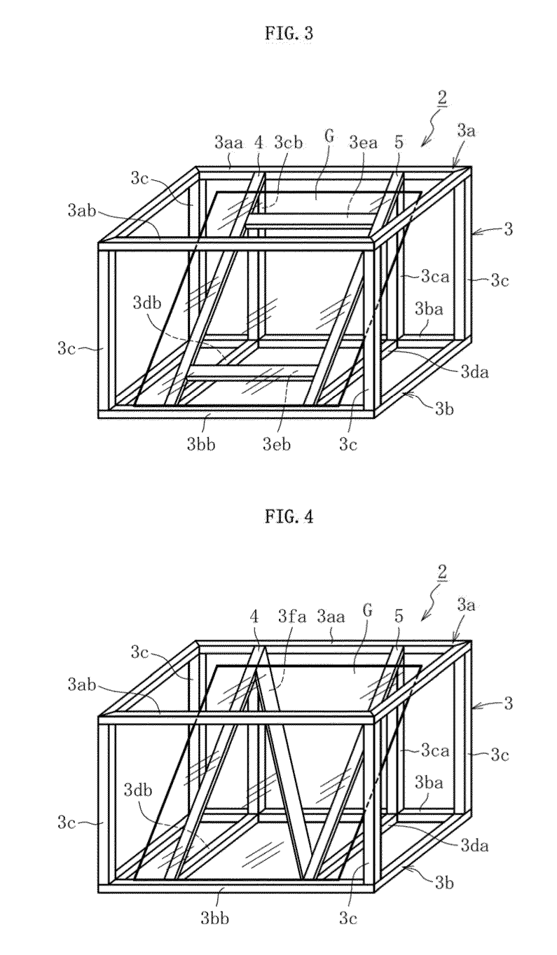

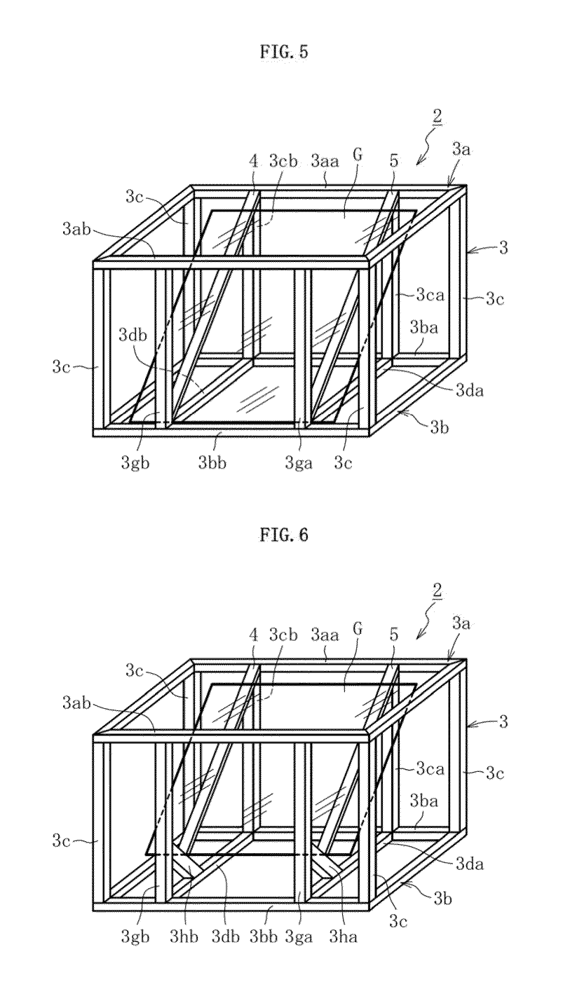

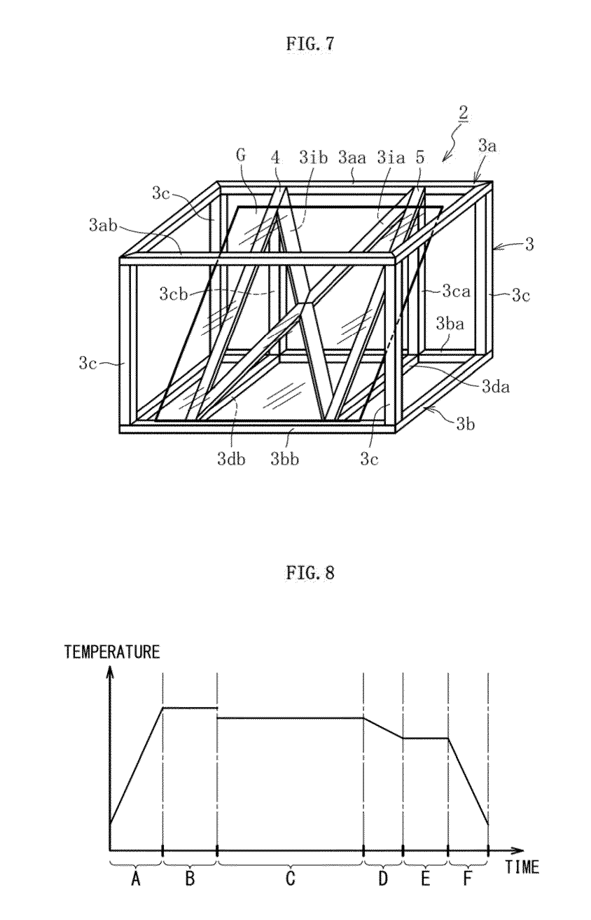

First, the warping amount of each tempered glass substrate (long side dimension of 1,500 mm×short side dimension of 1,200 mm×thickness of 0.3 mm; long side dimension of 1,500 mm×short side dimension of 1,200 mm×thickness of 0.5 mm) was simulated through use of a support jig (Type B) similar to the support jig illustrated in FIG. 3. Herein, as illustrated in FIG. 9, the long side dimension of the glass substrate G was defined as “L”, and the short side dimension of the glass substrate G was defined as “l”. The interval between an end portion on the short side of the glass substrate G and the pair of support frame materials 4, 5 of the tilt support portion was defined as “A”, and the interval between the end portion on the long side of the glass substrate G and the coupling frame materials 3ea, 3eb was defined as “B”. It should be noted that the interval A between the end portion on the short side (end portion on the left side of the figure) of the glass substrate G and the support frame material 4 on one side of the tilt support portion was set to be equal to the interval A between the end portion on the short side (end portion on the right side of the figure) of the glass substrate G and the support frame material 5 on the other side of the tilt support portion, and the interval B between the end portion on the long side (end portion on the upper side of the figure) of the glass substrate G and the coupling frame material 3ea on the upper side was set to be equal to the interval B between the end portion on the long side (end portion on the lower side of the figure) of the glass substrate G and the coupling frame material 3eb on the lower side. Table 4 and FIG. 11 show the results of the simulation.

As is apparent from Table 4 and FIG. 11, it is understood that, in the case where the ion exchange treatment is performed in a state in which the glass substrate is tilted, the warping amount can be reduced to within a predetermined range even when the glass substrate is large and thin. It should be noted that, when 6 graphics illustrated in FIG. 11 are checked with reference to the above-mentioned colored indices, most of the regions show a low tensile stress value, and hence it can be understood that all the tempered glass substrates have a small warping amount.

### Experiment 3

First, the warping amount of each tempered glass substrate (long side dimension of 1,500 mm×short side dimension of 1,200 mm×thickness of 0.3 mm; long side dimension of 1,500 mm×short side dimension of 1,200 mm×thickness of 0.5 mm) was simulated through use of a support jig (Type B) similar to the support jig illustrated in FIG. 3. Herein, as illustrated in FIG. 9, the long side dimension of the glass substrate G was defined as “L”, and the short side dimension of the glass substrate G was defined as “l”. The interval between an end portion on the short side of the glass substrate G and the pair of support frame materials 4, 5 of the tilt support portion was defined as “A”, and the interval between the end portion on the long side of the glass substrate G and the coupling frame materials 3ea, 3eb was defined as “B”. It should be noted that the interval A between the end portion on the short side (end portion on the left side of the figure) of the glass substrate G and the support frame material 4 on one side of the tilt support portion was set to be equal to the interval A between the end portion on the short side (end portion on the right side of the figure) of the glass substrate G and the support frame material 5 on the other side of the tilt support portion, and the interval B between the end portion on the long side (end portion on the upper side of the figure) of the glass substrate G and the coupling frame material 3ea on the upper side was set to be equal to the interval B between the end portion on the long side (end portion on the lower side of the figure) of the glass substrate G and the coupling frame material 3eb on the lower side. Table 4 and FIG. 12 show the results of the simulation.

As is apparent from Table 4 and FIG. 12, it is understood that, in the case where the ion exchange treatment is performed in a state in which the glass substrate is tilted, the warping amount can be reduced to within a predetermined range even when the glass substrate is large and thin. It should be noted that, when 6 graphics illustrated in FIG. 12 are checked with reference to the above-mentioned colored indices, most of the regions show a low tensile stress value, and hence it can be understood that all the tempered glass substrates have a small warping amount.

It should be noted that, when the ion exchange treatment is performed in a state in which the glass substrate is supported in a vertical direction, it is considered that the glass substrate is buckled due to the own weight with a slightly deformed part being an origin, with the result that the warping amount falls within an unreasonable range. Further, in Experiments 1 to 3, the conditions for the preheating step and the annealing step are not sufficiently studied. However, in order to reduce the warping amount of the tempered glass substrate, it is desired to provide the preheating step and the annealing step as described above.

### INDUSTRIAL APPLICABILITY

The manufacturing method for a tempered glass substrate of the present invention is suitable for a cover glass for a large-screen TV, a digital signage display, a touch panel display, an electronic blackboard, a solar cell, or the like. Further, the manufacturing method for a tempered glass substrate of the present invention can be expected to find use in applications requiring high mechanical strength, for example, manufacturing methods for a window glass, a substrate for a magnetic disk, a substrate for a flat panel display, a cover glass for a solar cell, and a cover glass for a solid image pick-up element, in addition to the above-mentioned applications.

### REFERENCE SIGNS LIST

G glass substrate
2 support jig
4, 5 tilt support portion (support frame material)
3ea, 3eb tilt support portion (coupling frame material)
3ca, 3cb side part reinforcing frame material
3da, 3db bottom part reinforcing frame material
3ha, 3hb shift preventing frame material

1. A manufacturing method for a tempered glass substrate,
the manufacturing method comprising:
melting glass raw materials to obtain molten glass;
forming the molten glass into a sheet shape to obtain a glass substrate having a long side dimension of 1,000 mm or more and a short side dimension of 500 mm or more; and
performing ion exchange treatment in a state in which the glass substrate is tilted to form a compressive stress layer in a surface of the glass substrate.

2. The manufacturing method for a tempered glass substrate according to claim 1, wherein the ion exchange treatment is performed in a state in which the glass substrate is tilted by from 0.1° to 30° with respect to a vertical direction.

3. The manufacturing method for a tempered glass substrate according to claim 1, wherein the ion exchange treatment is performed in a state in which the glass substrate is tilted by causing a tilt support portion provided in a support jig to support the glass substrate.

4. The manufacturing method for a tempered glass substrate according to claim 3, wherein a value of (length dimension of a part of the tilt support portion held in contact with the glass substrate)/(total of length dimensions of four sides of the glass substrate) is 0.01 or more.

5. The manufacturing method for a tempered glass substrate according to claim 3, wherein the part of the tilt support portion held in contact with the glass substrate has an arc shape having a radius of curvature of 0.1 mm or more.

6. The manufacturing method for a tempered glass substrate according to claim 3, wherein the glass substrate is arranged so that an end portion on a short side or a long side of the glass substrate extends off from the tilt support portion outwardly by 1 mm or more.

7. The manufacturing method for a tempered glass substrate according to claim 3, wherein the tilt support portion provided in the support jig is formed of a plurality of members distanced from each other and a coupling member for coupling the plurality of members.

8. The manufacturing method for a tempered glass substrate according to claim 1, wherein the glass raw materials are blended so as to obtain a glass substrate having a liquidus temperature of 1,200° C. or less.

9. The manufacturing method for a tempered glass substrate according to claim 1, wherein the glass raw materials are blended so as to obtain a glass substrate having a liquidus viscosity of 10^{4.0} dPa·s or more.

10. The manufacturing method for a tempered glass substrate according to claim 1, wherein the glass raw materials are blended so as to obtain a glass composition comprising, in terms of mol %, 40 to 80% of SiO₂, 5 to 15% of Al₂O₃, 0 to 8% of B₂O₃, 0 to 10% of Li₂O, 0 to 20% of Na₂O, 0 to 20% of K₂O, 0 to 10% of MgO, and 8 to 16.5% of Al₂O₃+MgO, having a molar ratio (Li₂O+Na₂O+K₂O)/Al₂O₃ of from 1 to 3, a molar ratio Na₂O/Al₂O₃ of from 1 to 3, and a molar ratio MgO/Al₂O₃ of from 0 to 1, and being substantially free of As₂O₃, PbO, and F.

11. The manufacturing method for a tempered glass substrate according to claim 1, wherein the forming the molten glass into a sheet shape is performed by an overflow down-draw method.

12. The manufacturing method for a tempered glass substrate according to claim 1, wherein the ion exchange treatment is performed with respect to a glass substrate having a residual stress difference between opposing surfaces of 10 MPa or less.

13. The manufacturing method for a tempered glass substrate according to claim 1, wherein the ion exchange treatment is performed so that the tempered glass substrate has a compressive stress value of a surface of 300 MPa or more and a depth of layer of 10 μm or more.

14. The manufacturing method for a tempered glass substrate according to claim 1, wherein the manufacturing method is free of a step of polishing a surface of the glass substrate.

15. A tempered glass substrate, which is manufactured by the manufacturing method for a tempered glass substrate according to claim 1.

16. A tempered glass substrate, comprising a compressive stress layer in a surface, and having a long side dimension of 1,000 mm or more, a short side dimension of 500 mm or more, and a warping amount of 1% or less.

17. A manufacturing method for a tempered glass substrate,
the manufacturing method comprising:
melting glass raw materials to obtain molten glass;
forming the molten glass into a sheet shape to obtain a glass substrate having a long side dimension of 1,000 mm or more and a short side dimension of 500 mm or more;
preheating the glass substrate at a temperature of from (ion exchange temperature+50)° C. to (ion exchange temperature−50) ° C. for from 10 minutes to 2 hours; and
performing ion exchange treatment with respect to the preheated glass substrate to form a compressive stress layer in a surface of the glass substrate.

18. A manufacturing method for a tempered glass substrate,
the manufacturing method comprising:
melting glass raw materials to obtain molten glass;
forming the molten glass into a sheet shape to obtain a glass substrate having a long side dimension of 1,000 mm or more and a short side dimension of 500 mm or more;
performing ion exchange treatment with respect to the glass substrate to form a compressive stress layer in a surface of the glass substrate, to thereby obtain a tempered glass substrate; and
annealing the tempered glass substrate at a temperature of from 100° C. to 400° C. for from 30 minutes to 4 hours.
